(19) United States
(12) Patent Application Publication
(10) Pub. No.: US 2026/0184520 A1
(43) Pub. Date: Jul. 2, 2026

(54) UNLOADING CONVEYOR OF GRANULAR MATERIAL FROM A TRUCK OR TRAILER TO A GRAIN BAGGING MACHINE

(71) Applicant: AGROINDUSTRIA Y SERVICIOS G Y G S.R.L., Santa Fe (AR)

(72) Inventor: Gabriel Alberto Richiger, Santa Fe (AR)

(21) Appl. No.: 19/369,425

(22) Filed: Oct. 27, 2025

(30) Foreign Application Priority Data
Dec. 26, 2024 (AR) P20240103631

(51) Int. Cl. B65G 67/24; A01F 25/14; B65G 33/10; B65G 33/14; B65G 33/24; B65G 47/18

(52) U.S. Cl. CPC B65G 67/24; B65G 33/10; B65G 33/14; B65G 33/24; B65G 47/18; A01F 25/14; A01F 2025/145; B65G 2201/042

(57) ABSTRACT

A granular material unloader mounted on a bagging machine of the kind that stores agricultural staples such as corn and wheat in large diameter polyethylene silo bags hundreds of feet long. The unloader brings in grain or other granular materials from gravity discharge vehicles by sending forth a receiving trough that positions itself beneath the discharge downspouts of these vehicles, to then retrieve the trough and redeploy. This repositioning procedure is repeatedly executed throughout the silo bag filling process, continuing until the bag reaches its full length. The receiving trough is connected to a telescopic conveying auger composed of articulated tubular sections and the machine dispenses with hydraulic driven augers, relying instead on a wholly mechanical drivetrain.

### FIELD OF THE INVENTION

The present invention refers to an unloading conveyor of granular material from a truck or trailer to a grain bagging machine, designed to transfer granular, flowable material such as grain, pellets or dry sand from the discharge downspouts or nozzles of trucks, trailers, grain carts or other vehicles.

More precisely, the present invention relates to a conveying system capable of delivering said kind of granular material at ground level or near-ground level, thereby configuring a mechanically driven conveying system for grain bagging machines of the type that fill up agricultural silo bags.

### BACKGROUND OF THE INVENTION

Publish patent application US20160039545A by Stumpe and Schmidt discloses an auxiliary swing auger to feed material from a gravity wagon or trailer to a bagger. Variations of this model were manufactured in several countries. A mechanical drive powers both the compression auger and the swing auger, which is deployed as a rigid one-piece tube. In the above-mentioned application, a simple gravity trough receives the grain from the conveying vehicle. Eventually, because this type of trough or hopper is too high to fit under the downspout of standard grain transporting vehicles as well as deficient in its grain throughput capability, manufacturers resorted to flat receiving troughs fitted with sweep augers. One relevant limitation encountered with this kind of swing auger is the loss of time incurred in maneuvering a receiving trough under the grain transporting vehicles.

This situation results from a confluence of factors: because the swing auger attached to the grain trough is a rigid unit with a fixed pivoting point, swinging the trough under a vehicle to position it beneath the latter's discharge downspouts requires it to describe an arc trajectory of a fixed radius, which makes it difficult to calculate where the grain transporting vehicle needs to stand to best intersect with the grain trough. This is especially so if there is not ample distance between the vehicle's wheel axles where its downspouts are located, requiring the vehicle or the receiving trough to execute additional movements. Even in the best-case scenario of having ample space between wheels, repositioning the receiving trough at frequent intervals as the bag increases in length is time-consuming.

From the standpoint that a swing auger pivots at the locus where it joins with the compression auger to deliver grain, all grain baggers mentioned in this specification are equipped with swing augers, including the machine of the present disclosure. The swing or conveying auger's function is to maintain its position beneath the transporting vehicle's discharge downspout while the bagger advances. Eventually, the delays and difficulties of positioning the trough under the transporting vehicle led to a newer generation of grain unloaders, machines able to extend and withdraw their conveying augers telescopically, i.e. in a straight line instead of in a fixed radius arc. This places the trough under truck or trailer in a straightforward manner, without vehicle wheels obstructing the maneuver and considerably reducing dead time. Two of these machines are described in more detail in the paragraphs that follow. On examination it will be observed that the conveying augers of these models are one-piece tubes detached from the main body of the bagger. To deploy for work, the conveying augers of these machines are transversely mobile and slide forward with the dual purpose of setting themselves in position beneath the grain transporting vehicles and of hooking up with their respective compression augers.

Accordingly, although the compression augers are driven by mechanical means provided by the tractor, the conveying augers are not connected to the mechanical drive and depend on a secondary power source, namely a hydraulic motor.

The first of the aforementioned machines is grain bagger model 1016T manufactured by Renn Mill Center Inc. It can be observed that this model has a conveying auger, driven by a hydraulic motor, which articulates at its distal end with a grain receiving trough that folds up for transport. The grain trough's plurality of sweep augers is powered by the conveyor's screw auger and so these parts are all driven by the same hydraulic motor. In this case the method used to deploy the conveyor entails it being held up by a support bracket, then making it slide down at an angle by means of hydraulic power and a rack and pinion mechanism. As it descends further, an aperture on the proximal lower section of its outer tube aligns and connects with an opening or mouthpiece on the upper section of the compression auger's outer tube to allow the passage of incoming grain. As it extends, the conveying auger simultaneously pushes the grain trough under the grain transporting vehicle to start receiving grain.

The second of the mentioned machines is a bagger made by Neeralta Manufacturing Inc. in Canada without a specific model ID. Its loading assembly comprises a receiving trough and a single section auger that in transport fits lengthwise at the side of the machine, its grain trough seated and secured in the rear panel of the bagger tunnel. On initiating work, the loading assembly is initially deployed by a hydraulic cylinder that swings the trough and the auger outward by about 90° so that they can project perpendicularly relative to the travel trajectory of bagging machine and transporting vehicle. Once pointed in that direction, the loading assembly slides down at an angle until the grain trough's travel wheels reach the ground, the entire assembly pushed by a hydraulic cylinder of considerable length to allow the grain trough sufficient reach.

The loading assembly is driven by a hydraulic motor longitudinally mounted at the proximal end of the conveying auger such that it directly connects with the auger's inner screw. This hydraulic array subsequently drives the trough's sweep augers as well, an arrangement similar to Renn's drive system previously examined. Besides the hydraulic motor, at its proximal end the conveying auger is fitted with a discharge spout. Once the auger is positioned for work, this spout lines up with a small hopper installed at the receiving end of the compression auger, establishing the circuit that feeds grain to the bagger.

### SUMMARY OF THE INVENTION

The present invention refers to an unloading conveyor of granular material from a truck or trailer to a grain bagging machine, designed to transfer granular, flowable material such as grain, pellets or dry sand from the discharge downspouts or nozzles of trucks, trailers, grain carts or other vehicles capable of delivering said kind of material at ground level or near-ground level, thereby configuring a mechanically driven conveying system for grain bagging machines of the type that fill up agricultural silo bags.

The unloading conveyor comprises a granular material receiving trough that moves close to the ground and fits beneath the discharge downspouts of vehicles that transport said granular material, said receiving trough equipped with a plurality of sweep augers that collect said granular material.

A conveying auger comprising three articulated and consecutive tubular sections (1), (2) and (3) is attached at its distal end to said receiving trough, wherefrom it receives said granular material. Said tubular sections are linked through horizontally oriented articulation axes allowing them to fold and unfold on a vertical plane. The terminal tubular section (3) connects to a rotatable hopper through a horizontal articulation axis, said rotatable hopper being mounted on a turntable whereby it can rotate on a horizontal plane. When the tubular sections are deployed, the conveying auger connects said receiving trough with said rotatable hopper to define a continuous passageway for said granular material.

Beneath said rotatable hopper is positioned a compression auger fitted with a mouthpiece through which said granular material enters, said compression auger arranged transversely relative to said conveying auger, such that said mouthpiece and said rotatable hopper are directly connected to permit uninterrupted throughput of said granular material toward the compression auger.

The tubular sections (1), (2) and (3) are configured to fold or retract vertically for stowing when not in operation and to unfold or extend when in use, thereby forming a functional conveying auger whose inner screw segments engage automatically to form an integrated screw that transmits rotational movement. Said tubular sections are further interconnected by articulated hinges comprising scissors-like pivoting blades actuated by hydraulic cylinders that fold and unfold the sections, including a hinge between each adjoining pair of tubular sections and between the last tubular section and said rotatable hopper.

The receiving trough may further comprise freely rotatable wheels and drive wheels powered by hydraulic motors, allowing forward and backward ground movement coordinated with the rotation of said rotatable hopper. The conveying system is mechanically driven through rotational power transmitted from a tractor's power take-off or equivalent means to a dual output gearbox that distributes power to both the compression auger and the conveying auger, enabling the integrated operation of all components for the effective transfer of granular material from the transporting vehicle to the bagging machine.

The present application's main object is an unloading conveyor of granular material from a truck or trailer to a grain bagging machine. It is mounted on a grain bagging machine or bagger in order to convey to it granular material that is also flowable, generally grain such as corn, wheat or soybeans but also other materials as for example dry sand or pellets of fertilizer or other substances, from transport trucks and trailers equipped with bottom, side or rear discharge nozzles or downspouts. Thus, an integrated granular material conveying arrangement is established that conjoins a loading system and a bagging machine.

The machine or apparatus of the present application includes a grain receiving trough fitted with a plurality of sweep augers that is placed under a truck or trailers' bottom discharge hopper, downspout or nozzle from which the granulated material, i.e. normally grain, is discharged (the present specification will specifically refer to grain throughout for the sake of simplicity). The receiving trough connects to the distal end of a conveying auger. The conveying auger—also called in the literature a swing auger—will likewise be referred to as the conveyor for short. It consists, in the case of the present specification, of articulated tubular sections or conveyor sections, each of which contains within corresponding auger screw sections that disconnect and connect with one another as the articulated sections open (unfold) and close (fold). The mentioned components form part of the grain unloading or conveying section of the machine. At its proximal end the conveying auger converges to a compression auger that redirects the material toward the bagging section of the machine. The bagging section comprises the compression auger and a tunnel around which a folded silo bag is wrapped. The bagging section is in charge of packing the material in the silo bag which gradually releases its folds as it fills, and can extend several hundred feet on completion. The bagging section is very summarily referred to as no parts or function concerning said section is claimed in the present disclosure.

Henceforth, when referring to the grain receiving trough in combination with the conveying auger, the rotatable hopper to which the auger is attached, and the other parts that are part the unloading section of the machine, this fabrication will broadly be referred to as the conveying assembly or the unloader. The distal end of the conveying assembly, as well as the distal end of the conveying auger by itself, refers to that section which is farther away from the machine's central body. In contraposition, the proximal end is that nearer the central body. The term auger as used in this specification will normally cover the outer tube along with the corresponding inner screw when referring to the conveying auger or to any of its sections, or when referring to the compression auger. When referring to the sweep screws in the grain trough, they will be named simply as augers or sweep augers to use their most usual names in the trade, despite them not being encased within a tube. The delivery vehicle is that which brings in the grain, i.e. the granular material, which the unloader of the present disclosure will carry to the bagging section of the machine, and may also be referred to in this specification as a truck for convenience. However, the delivery vehicle need not be necessarily a truck; it could be a truck towing a bottom hopper trailer, a rear end dump truck or trailer, a gravity discharge grain wagon pulled by a tractor, or any kind of transport that can deliver material to the grain receiving trough at ground level.

The telescoping unloader described in the present specification addresses precisely the collection of grain at ground level. This type of unloader is mounted only in some bagger models, whereas all baggers are designed to receive grain from conventional grain carts fitted with long near-vertical augers. These near-vertical augers conduct the grain to large reception hoppers that baggers have in their topmost sections or mid-sections. This standard grain delivery system is not the object of the present disclosure.

The conveying auger's articulated or tubular sections fold and unfold and constitute a key feature of the disclosure. When folded for transport, the articulated sections adopt a vertical position. When deployed for work they execute a quick straightforward rectilinear movement: the receiving trough is projected horizontally over the ground, in a direction perpendicular relative to the bagger and the delivery vehicle's line of travel, to position itself beneath the discharge downspout of the latter.

All augers of the machine of the present disclosure are driven mechanically through gear cases, universal joint assemblies, couplings and drive shafts. This design is simple, reliable and easy to operate. Being entirely mechanical, it is not limited by constraints in hydraulic capacity.

The grain unloader integrates with a grain bagger to configure a unified machine. It possesses a conveying capacity of hundreds of metric tons per hour and is a practical contraption for beginning and ending the bagging procedure as it positions itself facing the downspouts of regular gravity discharge trucks and trailers used in many countries.

The present disclosure defines a new configuration that works more efficiently in terms of improved operational speed, with less time spent in positioning the receiving trough. This maneuver is unavoidable in any bagging process because the bagger may have to advance up to five hundred feet to fill a single bag. Since the bag itself is unmovable, the delivery vehicle must frequently advance to keep up with the bagger; approximately every 25 ft. or so of lengthening bag signals new repositioning of the vehicle. At every detention the unloader first retrieves and then re-extends its loading assembly. As will be seen, the manner in which the present machine performs this task shows a marked improvement over previous art machines with regards to the sheer volume of material it can handle, and the time saved when repositioning.

### ADVANTAGES OF THE PRESENT DISCLOSURE

A prime advantage of the disclosed machine is that all of its augers are mechanically driven right down to the grain trough's sweep augers. Precisely, the folding ability of the grain conveying tube is what allows the main mechanical transmission to cohesively drive all of the unloader's augers, which connect and disconnect automatically. Until now, 100% mechanical drive had not been accomplished by any telescopic conveying system mounted on a bagging machine. Instead, these machines have relied on hydraulic motors.

Hydraulically driven systems are the bottleneck of loading systems: they are notoriously inefficient at performing heavy tasks of extended duration and are simply not powerful enough to move very large amounts of grain. Hydraulic motors have some weak points such as a tendency to overheat if forced; e.g., if grain being conveyed is moist, it places more of a workload on the motor and the hydraulic fluid can heat up and thin, reducing lubrication and increasing component wear. Not only would it be costly to install larger and heavier hydraulic motors, but it would also defeat the purpose because the limiting factors lie in tractor engine displacement and the OEM pumps and circuits that equip tractors; the simple fact is that standard agricultural tractor diesel engines cannot generate enough power to drive hydraulic pumps and motors larger than those used at present.

In comparison, mechanical drive derives directly from the tractor's engine, allowing the use of bigger grain troughs fitted with a larger number of sweep augers that can work at higher RPM, and of larger diameter conveyor augers. The 100% mechanically driven system of the present disclosure notably increases grain throughput compared with systems that include at least one work stage powered by hydraulics. Labor is more efficient, and fuel is saved in the process.

In transport position, the conveying assembly stands in vertical position against the machine's central body, its component parts flat against each other to configure a substantially compact array that does not protrude past the tunnel (the machine's widest section) and is not stashed in a more or less loose manner on the machine's flank, which could cause uneven weight distribution and issues when being towed.

Deployment of the conveyor does not require any prior steps such as swinging it outward before commencement of labor, or manual operations such as detaching the grain trough from its moorings. Unlike other machines that stash their conveying assemblies lengthwise at the side, the present conveyor always faces out at a perpendicular angle from the machine's line of travel, pointing in the right direction to start work by deploying its sections in true telescopic manner.

The conveying auger's tube is permanently connected to the compression auger's tube, so the loading of grain can be initiated at any moment with no previous preparatory moves. Unlike other machines, there is no time lost in aligning or connecting one tube with the other when the grain transporting truck periodically advances to keep up with the bagger.

The geometry of the tubular sections produces a very compact assembly when folded and a sturdy tubular assembly when extended. It allows faster extension and retraction movements than can be attained by rack & pinion devices and hydraulic cylinders that apply direct rectilinear force to propel one-piece conveying augers back and forth. Since repositioning is a cyclical maneuver that repeats numerous times when a bag is filled (i.e. every time the delivery vehicle has to change position), faster conveyor positioning moves adds up to significant time savings.

### Design Originality

As has been shown, there are several examples of devices mounted on bagging machines with the object of conveying granular material from transporting vehicles to said machines, but none of them propose, or even suggest, the construction solutions disclosed in the present specification. There are several non-patented examples in the market of devices that are mounted on a bagging machine to serve the same purpose of conveying grain or other flowable materials, some fitted with rigid loading augers that only swing in an arc of fixed radius, and some fitted with telescopic loading augers, but none of these models have adopted the solutions disclosed herein. Thus, the applicant submits the present disclosure of an innovative design that substantially improves the performance of these machines.

### BRIEF DESCRIPTION OF THE DRAWINGS

To illustrate the advantages of the present disclosure that were briefly touched upon, which those skilled in the art could add to, and to facilitate comprehension of the constructive and functional aspects of it, an exemplary embodiment is shown which because of its exemplary nature should not be construed as being limited to the characteristics outlined.

Further features and advantages of the invention will become apparent from the following detailed description taken in conjunction with the accompanying figures showing illustrative embodiments of the invention, in which:

FIG. 1 is a perspective view of the unloader for conveying granular material mounted on a bagging machine, in its retracted transport position.

FIG. 2 is a similar perspective view of the unloader in its extended work position.

FIG. 3 is a parallel projection view of the conveying auger of the disclosed unloader without wheels attached.

FIG. 4 is a parallel projection front view of the machine fully retracted in transport position, detailing some components visible from this viewpoint.

FIG. 5 is a similar front view in which the machine begins to deploy its conveying assembly for work.

FIG. 6 is a similar front view in which the machine is fully extended in work position.

FIG. 7 is a perspective view of the conveying assembly's third articulated hinge.

FIG. 8 is a perspective view of the conveying assembly's third hydraulic cylinder leaning to the right side when the conveyor is displaced forward.

FIG. 9 is a perspective view of the conveying assembly's third hydraulic cylinder leaning to the left side when the conveyor is displaced backward.

FIG. 10 is a perspective view of the unloader standing at the side of a grain transporting truck, its conveyor partially deployed.

FIG. 11 is a perspective view of the unloader at the side of a grain transporting truck, its conveyor fully deployed under the truck's discharge downspout.

FIG. 12 shows a top view parallel projection of the unloader positioned at the beginning stage of a loading cycle.

FIG. 13 shows a top view parallel projection of the unloader positioned at the end stage of a loading cycle.

FIG. 14 shows a perspective view of the lower section of the conveyor attached to the grain trough, with hydraulic drive wheels raised up and frontally oriented freely rotatable wheels on the ground.

FIG. 15 shows a perspective view of details of the lower section of the conveyor, with hydraulic drive wheels on the ground.

FIG. 16 shows a perspective view of the conveyor's freely rotatable wheels standing on the ground.

FIG. 17 shows a perspective view of the conveyor's freely rotatable wheels raised up in the air.

FIG. 18 shows a perspective view of the second and third tubular sections in open position, and the latter linked to the conveying assembly's rotatable hopper.

FIG. 19 shows the same perspective view of the previous figure with the second and third tubular sections in closed position.

FIG. 20 is a cutaway perspective view of the unloader for conveying granular material mounted on a bagging machine, with a cutaway view showing its conveying and compression auger screws.

FIG. 21 is a cutaway perspective detailed view of transmission components at the point where the powertrain initiates.

FIG. 22 is a cutaway perspective view of the powertrain components that drive the conveying assembly.

FIG. 23 is a perspective view illustrating how drive components accompany the conveyor's frontward rotation.

FIG. 24 is a perspective view illustrating how drive components accompany the conveyor's rearward rotation.

FIG. 25 is a cutaway perspective view of the conveying auger's inner screw and part of the inner works of the grain receiving trough, as seen from the side.

FIG. 26 is a detailed cutaway perspective view of the grain trough drive shaft at the point where it connects with the conveying auger's inner screw, seen sideways.

FIG. 27 is a cutaway perspective view, as seen from above, of the sweep augers within the grain trough and their transmission gears.

FIG. 28 is a cutaway parallel projection view of the grain trough's transmission gears and drive chain.

### A LIST OF PARTS IS HEREBY PROVIDED FOR EASE OF REFERENCE

First tubular section
2) Second tubular section
3) Third tubular section
4) Conveying auger/conveyor
5) Granular material receiving trough
6) Rotatable hopper
7) Mouthpiece
8) Compression auger
9) Support bracket (hinge 19)
10) PTO drive shaft
11) First hydraulic cylinder (conveyor)
12) Second hydraulic cylinder (conveyor)
13) Third hydraulic cylinder (conveyor)
14) First articulation axis
15) Second articulation axis
16) Third articulation axis
17) First articulated hinge
18) Second articulated hinge
19) Third articulated hinge
20) Articulated blades (hinges 17 and 18)
21) Pivot pins (welded to tubular sections)
22) Freely rotatable wheels
23) Drive wheels
24) Gear reducers and swing arms (drive wheels)
25) Pins (U-brackets)
26) Hydraulic motors
27) Hydraulic cylinders (drive wheels)
28) Hydraulic cylinders (freely rotatable wheels)
29) Swing arms (freely rotatable wheels)
30) First articulated arm (hinge 19)
31) Second articulated arm (hinge 19)
32) Piston rod pins
33) Barrel pin
34) Piston rod pin w/ball & socket joint
35) Barrel pin w/ball & socket joint
36) Pivot pins (hinge 19)
37) Ball bearing turntable
38) Rectangular bases
39) Double universal joint
40) Right angle dual output gearbox
41) Roller chain drive
42) Second transmission gear
43) Inner screw (compression auger)
44) Telescopic drive shaft
45) 1st right angle gearbox
46) 2nd right angle gearbox
47) Roller chain coupling
48) Inner screw (conveying auger)
49) Fairing slot
50) Barrel support brackets (conveying auger hydraulic cylinders)
51) Driving shaft (receiving trough)
52) Universal joint assembly
53) Driving sprocket
54) Sweep augers
55) Driven sprockets
56) Roller chain drive (trough augers)
57) Upper grain hopper
58) Bag tunnel
59) Tubular section flanges

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

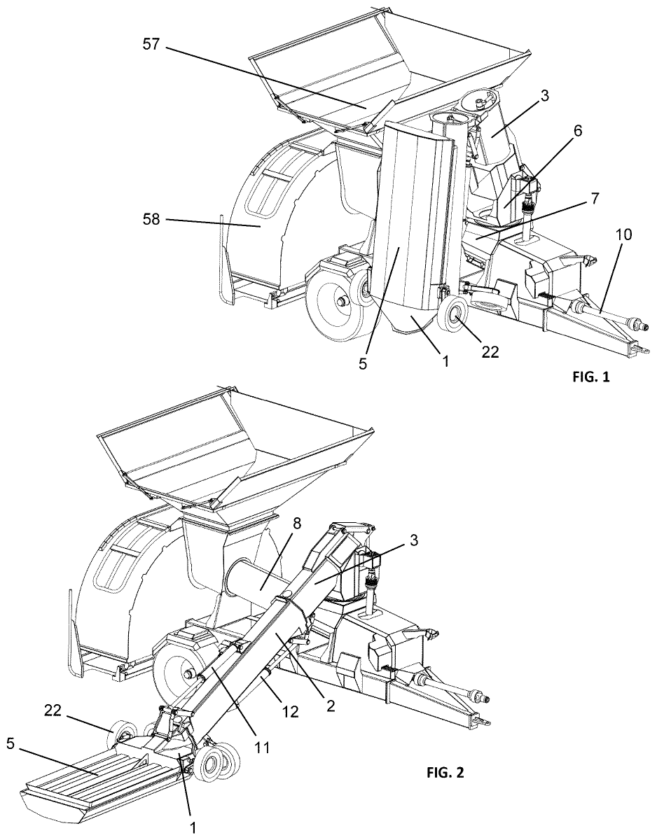

As observed in FIGS. 1 and 2, the granular material or grain unloader of the present disclosure integrates with a bagging section to constitute a unified grain bagging machine.

FIG. 1 depicts the conveying assembly in its closed or retracted position. FIG. 2 shows it in its open or extended position as designed for receiving grain from different kinds of transporting vehicles capable of delivering granular material at ground level. The conveying auger 4 by itself consists of three connected sections identified respectively as tubular or section 1, tubular section 2, and tubular or section 3. To conveying auger 4 is attached grain receiving trough 5 that receives the incoming grain.

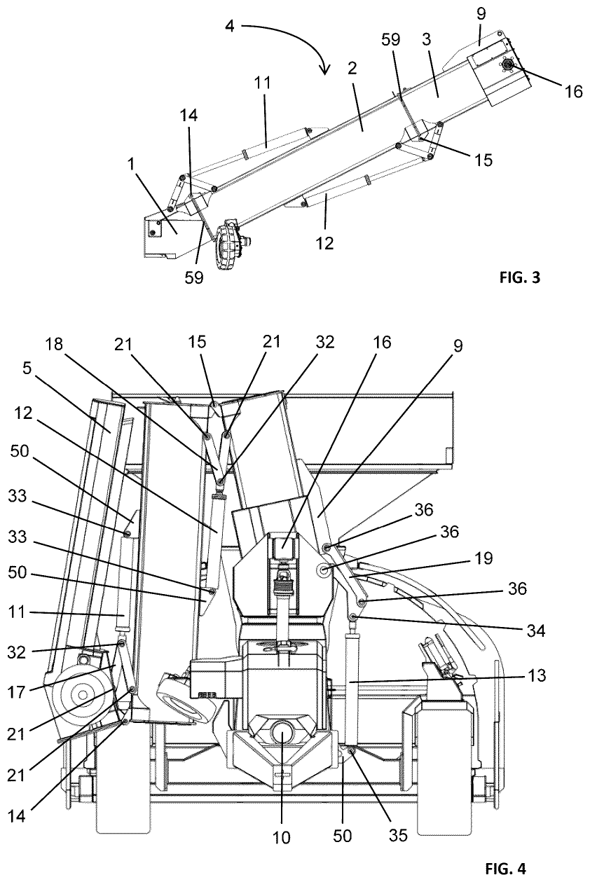

FIG. 3 specifically represents conveying auger 4 with its corresponding tubular sections 1, 2 and 3, along with grain trough 5, for easier visualization as a distinct component from the rest of the machine.

FIGS. 1 and 2 show other parts that belong to the conveying assembly. These parts are rotatable hopper 6 and mouthpiece 7 that link conveying auger 4 and compression auger 8 to finish configuring the grain feed circuit. Rotatable hopper 6 is as much a turret as it is a hopper. It allows granular material in, but is heavily built to support the weight of the conveying assembly and also possesses circular motion.

Just for the purpose of illustration, some parts shown in FIGS. 1 and 2 pertain specifically to the machine's bagging section. These are upper grain hopper 57 and a bag tunnel 58 on which the silo bag is arranged as a pleated polyethylene tube in a ring format. On beginning the bagging procedure, the first pleats or folds are pulled out and sealed so that the initial open ring becomes a tube or silo bag closed at one end that unfolds gradually as it fills with grain forced in and packed tight by compression auger 8.

In FIG. 2 specifically it can be seen that hydraulic cylinders 11 and 12 intervene in extending forth the tubular conveying assembly from its retracted format of FIG. 1, along with a third hydraulic cylinder 13, not visible here (see FIGS. 3, 4 & 5). It can be seen that the machine receives power derived from a tractor's power take-off by means of a drive shaft 10. Other distinct parts of the unloader that will be reviewed shortly are freely rotatable wheels 22 and hydraulically powered drive wheels 23.

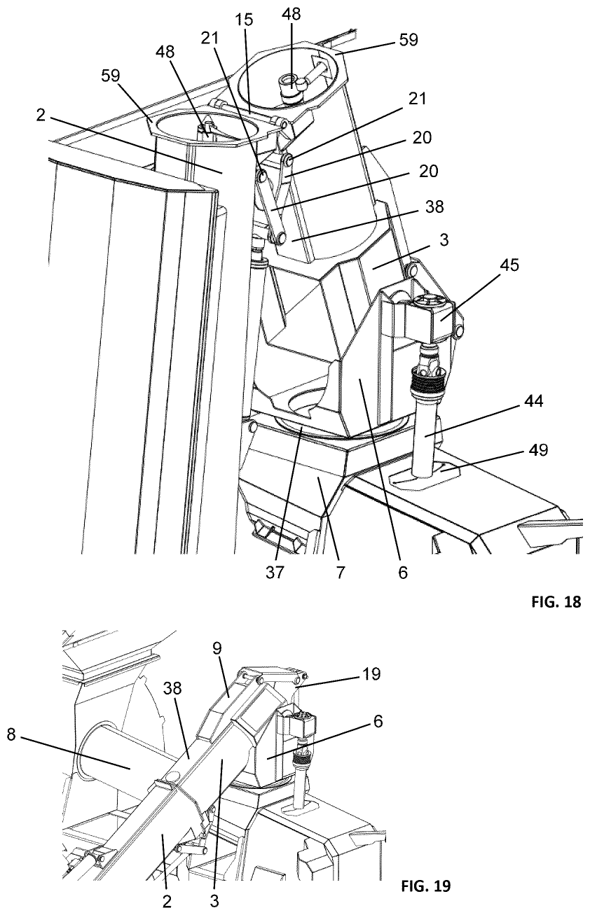

With regards to FIG. 3 and the conveying auger 4 it depicts, it can be seen that tubular section 1 is linked to tubular section 2 through a first articulation pin or axis 14 and that tubular section 2 is linked to tubular section 3 through a second articulation pin or axis 15, whereas tubular section 3 is linked to rotatable hopper 6 through a third articulation axis 16. The location of articulation axis 16 is shown independently of its linkage to rotatable hopper 6, the latter not shown in FIG. 3 since it is not strictly a part of conveyor auger 4. Articulation axes 14, 15 and 16 are the points at which the tubular sections of conveying auger 4 rotate to close or open. Flanges 59 provide the contact surface between tubular sections 1, 2 and 3 when these extend for work (see also FIG. 18).

Now, with the front-end view provided by FIGS. 4, 5 and 6, it is possible to appreciate the mechanisms that determine the sequence of moves.

It should be noted that for all intents and purposes tubular section 1 is a continuation of grain trough 5 and they could well be specified as a single integrated unit, which would not alter the present disclosure's concept. However, they are designated as separate components to emphasize the conveying auger's compartmentalization in at least three articulated sections as a basic functional feature of the present disclosure.

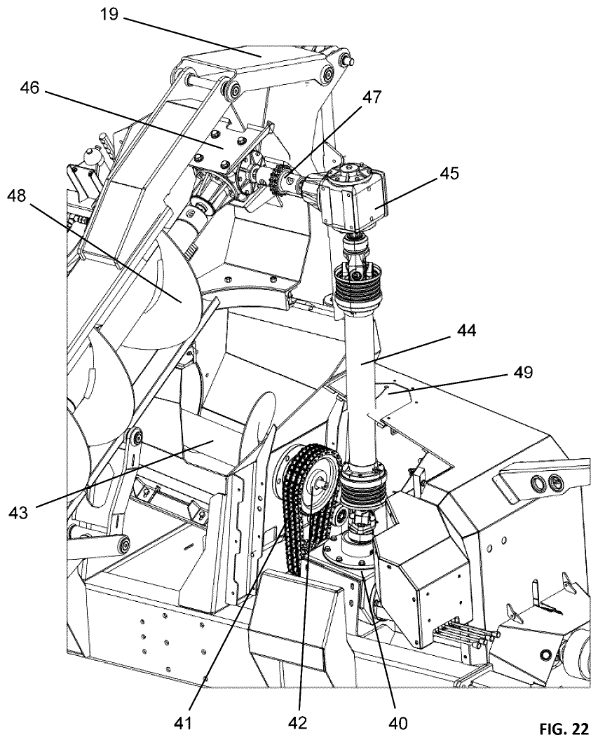

FIG. 4 shows the unloader in its maximum retracted position, which is normally used only when transporting the machine. The hydraulic cylinders are closed, their piston rods fully withdrawn inside the cylinder barrels. Grain trough 5 is in vertical non-operational position conjoined with tubular section 1 and adjacent to tubular sections 2 and 3 also in vertical or near-vertical positions, all mentioned parts compactly stowed for road travel. Besides hydraulic cylinders 11 and 12 already mentioned, cylinder 13 that connects tubular section 3 with hopper 6 is shown. Also shown are hinges 17, 18 and 19 that link the three sections of conveying auger 4 and rotatable hopper 6. Cylinders 11, 12 and 13 actuate directly on hinges 17, 18 and 19 to open and close the conveying assembly as it goes through all its extension and retraction stages. FIG. 4 also shows articulation axes 14, 15 and 16. Axis 16 is not visible as it is not simply an articulation pin as axes 14 and 15, but in integrated into the drive system that powers conveying auger 4. Thus, although the arrow corresponding to axis 16 points at gear case 45 (see FIG. 22), in this drawing it represents the location of the pivoting point at which tubular section 3 swivels.

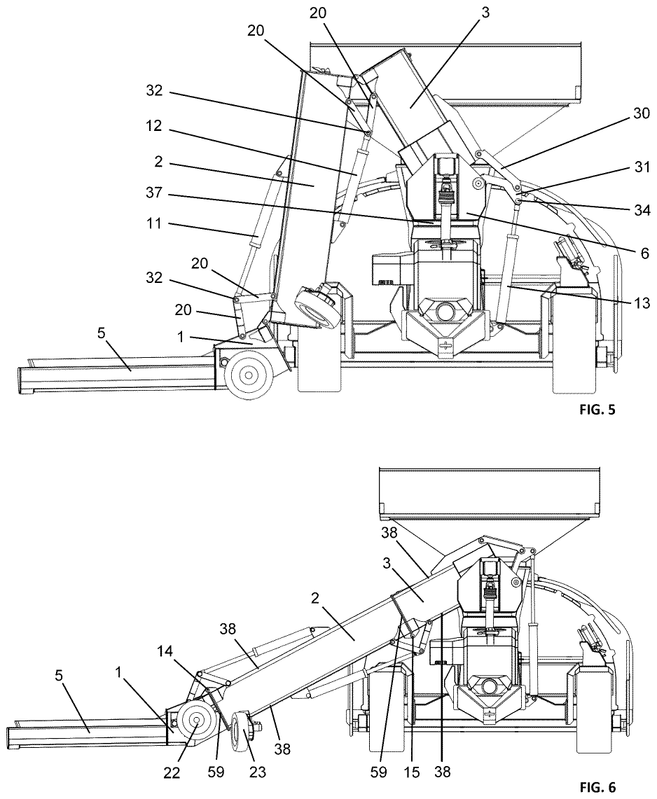

FIG. 5 shows the conveyor gradually spreading out or closing in, as can be seen by the cylinders' lengthier piston rods compared with FIG. 4. It is a position adopted repeatedly, when the grain truck advances to catch up with the unloader. Grain trough 5 normally remains lowered at all times during grain unloading maneuvers. All three hydraulic cylinders 11, 12 and 13 are connected in series and will deploy in a predetermined order: cylinder 11 opens first to set the trough 5 on the ground to then have the others follow; retraction follows the inverse order with cylinder 11 closing last, wherefore if its closure is taken to termination the conveyor and grain trough 5 go back to the position shown in FIG. 4. Other sequencing order of the cylinders could be arranged. In the way it is arranged, time is gained because the trough need not initiate from vertical when the conveying assembly is thrust forward time and again to begin the next work cycle. In FIG. 5 hinges 17 and 18 of FIG. 4 are identified by their component blades 20.

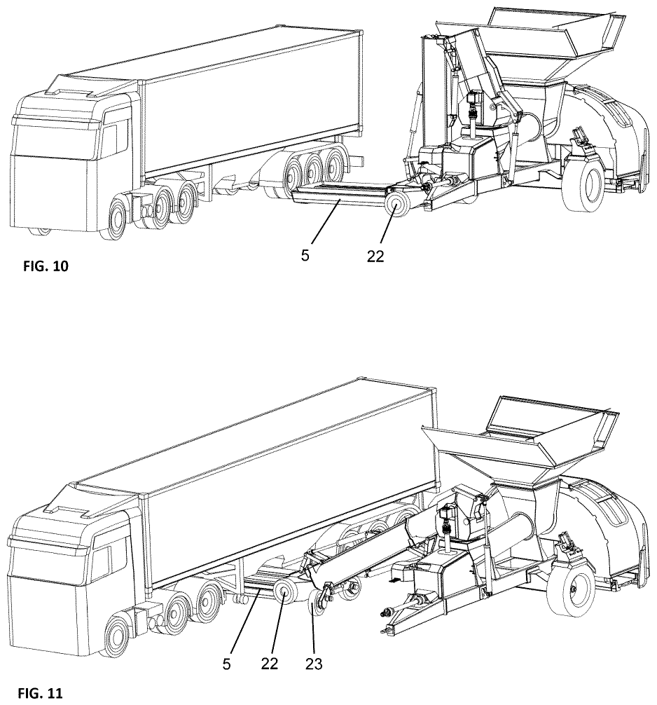

FIG. 5 also shows grain trough 5 resting on the ground on a set of freely rotatable wheels 22 located at its sides, so that when tubular sections 2 and 3 deploy, the entire conveying assembly moves forward with rectilinear motion to directly place grain trough 5 under the truck's discharge downspout (see FIGS. 10 and 11).

FIG. 6 shows the conveyor in its extended work position, cylinders 11, 12 and 13 fully open, tubular sections aligned with one another forming a single tube, grain trough 5 positioned under the truck's discharge ready to receive grain, and drive wheels 23 set on the ground to move the conveying auger sideways if required. Although not visible in these figures, the tubular sections contain within corresponding screw segments that link together when the conveyor is deployed.

In the same FIGS. 3, 4, 5 and 6, it can be observed that the swivel action of tubular sections 1, 2 and 3 is controlled through hydraulic cylinders 11, 12 and 13, which respectively operate articulated hinges 17, 18 and 19. Articulated hinges 17 and 18 conjoin adjacent tubular sections by means of pairs of scissors-like components aligned transversally slightly off-center at the left and right sides of each tubular section to prop and stabilize them (FIGS. 15 and 18). The scissors-like components of hinges 17 and 18 comprise articulated blades 20 linked together at one end by piston rod pins 32, and these pins are connected to and actuated on by respective hydraulic cylinders 11 and 12. At their free ends, opposite the ends through which piston rod pins 34 run through, articulated blades 20 articulate with pivot pins 21 that are welded to rectangular bases 38, rectangular bases aligned along the top and bottom of tubular sections 1, 2 and 3 as can also be appreciated in more detail in FIGS. 18 and 19 amongst others. Furthermore, steel plates can be welded across one or both pairs of blades 20 arranged transversally across each tubular section to increase torsional rigidity. Thus hinge 17 links tubular sections 1 and 2, whereas hinge 18 links tubular sections 2 and 3. At their barrel ends, hydraulic cylinders 11, 12 and 13 are attached to support brackets 50 that allow free pivoting through barrel pins 33 and 35.

Articulated hinge 19 that links tubular section 3 and hopper 6 is constructed differently than hinges 17 and 18 to allow control over the conveying assembly's extension and retraction maneuvers while withstanding high torsional and axial loads, as will be explained.

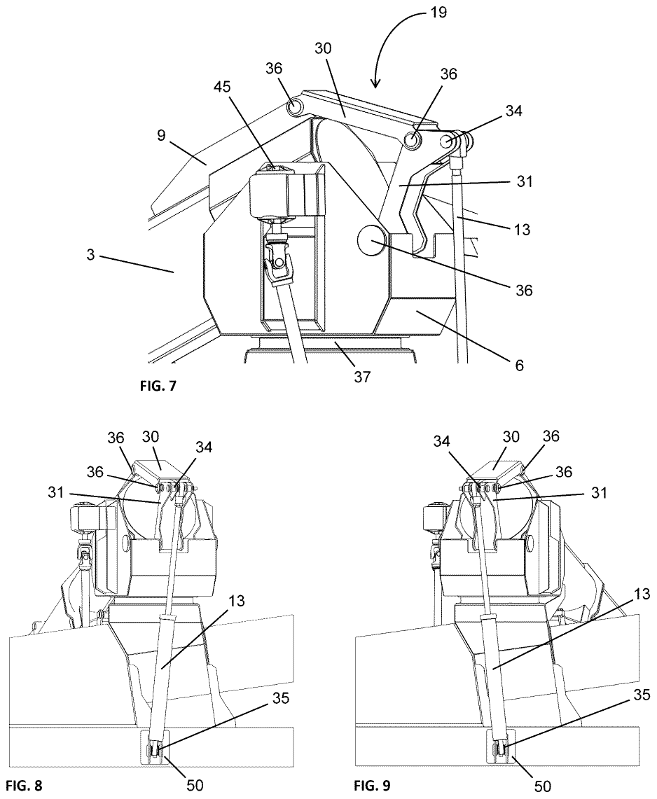

Seen from the front of the machine in FIG. 7, hinge 19 has a first articulated arm 30, a one-piece solid steel plate that links at one end to support bracket 9 welded on the proximal extremity of tubular section 3 and at its other end with a second steel plate articulated arm 31, both linkage points articulated by pivot pins 36. Articulated arm 31 is characterized by two offset protrusions or extensions that give it a “U” shaped appearance, one protrusion linked to rotatable hopper 6 by a third pivot pin 36 and the other protrusion linked to hydraulic cylinder 13 through a piston rod pin 34, resulting in articulated arm 31 having 3 pivot pins. Thus hinge 19 articulates around 4 pins of arms 30 and 31 instead of 3 pins as is the case of hinges 17 and 18. The offset protrusion of arm 31 that links to hydraulic cylinder 3 serves the purpose of a lever that uses articulated arm 30 as a kind of fulcrum to gain more reach and apply more efficient pulling force.

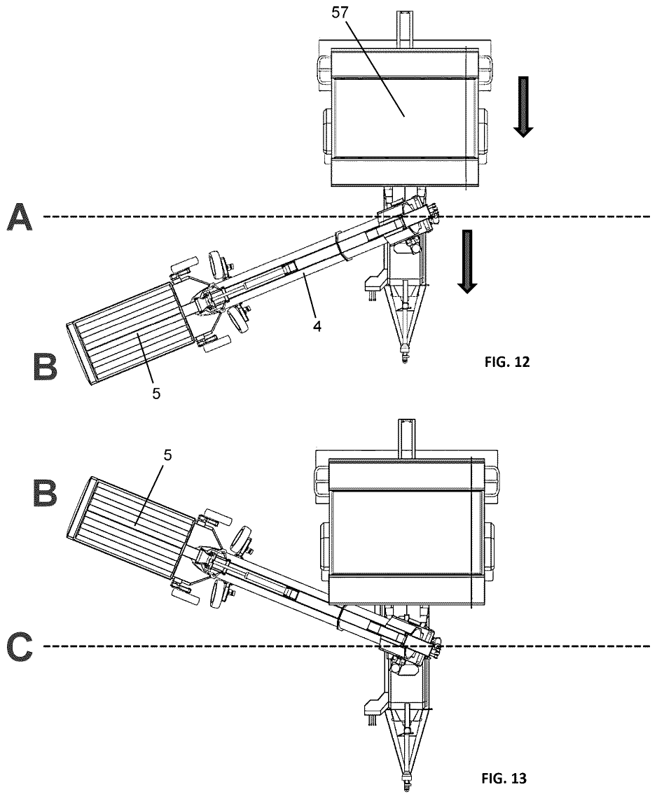

Looking now at FIGS. 8 and 9, which show hinge 19 and the anchoring points of cylinder 3, it can be seen that FIG. 8 depicts the conveyor positioned in a frontward angle as shown in FIG. 12, and that FIG. 9 depicts the conveyor positioned in a rearward angle as shown in FIG. 13. The conveyor works at varying angles that differ from a perpendicular angle and oftentimes it needs to be retrieved when positioned at such angles. In any of these circumstances, it can be seen that when rotatable hopper 6 abandons its initial 90° right angle position to accompany the conveyor, if the hydraulic cylinder were to be rigidly connected to said conveyor, the torsional and axial loads generated would lead to mechanical damage and system failure. To prevent this, the anchoring of hydraulic cylinder 13 to hinge 19 and to its support bracket 50 is through ball and socket joints that are interposed with piston rod pin 34 and barrel pin 35 respectively, whereby they form integrated assemblies. These integrated ball and socket assemblies provide rotational and angular mobility at the locus of pins 34 and 35 to alleviate torsional and axial stresses.

Thus in FIG. 8 cylinder 13 can be seen tilted toward the right side as it aligns with the conveyor oriented frontward, whilst in FIG. 9 it can be seen tilted toward the left side as it aligns with the conveyor oriented rearward. Whether pulling in or pushing out at an angle, the cylinder and its anchor points will not experience undue strain because of the ball and socket articulations at the pivot points of hydraulic cylinder 3. When being retrieved at an angle, the conveyor comes in at that same angle until the final stage when the grain trough lifts off the ground and the conveying assembly self-centers as it folds against the machine frame (FIG. 4).

FIGS. 10 and 11 show the relative positions of the unloader relative to a truck or other grain delivery vehicle.

Specifically, FIG. 10 shows the truck parked with one of its discharge downspouts (grain gravity discharge trucks and trailers usually have two nozzles or downspouts in between their axles) aligned with the conveyor's grain trough 5 already set on the ground, a position similar to that depicted in FIG. 5.

Similarly, FIG. 11 shows the unloader already deployed in work position with its grain trough in position beneath the discharge downspout, a position similar to that depicted in FIG. 6.

Now observing FIGS. 12 and 13, it can be seen that once deployed in its extended work position, the conveying assembly has the capability of swinging around a vertical axis with fixed angular endpoints, which serves a twofold purpose.

The first purpose of the conveyor's swing capability is to maintain the grain trough in a fixed spot right under the truck's discharge downspout when the bagger advances, so that an uninterrupted flow of grain is provided for the silo bag.

The second purpose is the option of maneuvering the trough's position during any stage of the procedure, typically when it is already located under the truck's frame. This is carried out by hydraulic drive wheels 23 installed in first tubular section 1. To exemplify, the conveyor deploys perpendicularly to the bagger's line of travel, but the truck will stand slightly ahead so that the conveyor does not point directly at a downspout but rather at its rear, as much as the truck's axle and wheels will allow. It is common for trucks and trailers to have at least two divisions in their carrying bins, and thus two downspouts. In this case it is better to initially aim the conveyor at a spot that is nearer the second downspout, the one located at the rear, and then utilize the trough's self-motion capability to swing it forward until it is positioned under the first downspout, the one nearest the truck's cabin (see FIG. 12).

As an operational example, FIG. 12 depicts the initiation of a work cycle. The conveyor is first deployed at a right angle from the machine as shown in FIG. 11, represented in the drawing with dotted line “A” that traverses the vertical pivot axis of the conveying assembly. Its drive wheels 23 then carry it to point “B”, located under the truck's first downspout, where it remains static. Once grain begins pouring into grain trough 5, the compression auger forces the grain into tunnel 57 and consequently into the silo bag, resulting in the machine and the tractor being pushed forward as the bag expands and grows in length (the tractor provides the drive power, but its transmission is set in neutral gear). Neither tractor nor silo bag attached to tunnel 57 are portrayed.

FIG. 13 depicts the termination of a work cycle. After the bagger has traveled some meters pushed forward by the lengthening bag and the conveyor has reached the endpoint of its swing angle, trough 5 has remained under the truck's downspout in the same spot “B”, albeit having changed its orientation as the bagger advances. Dotted line “C” that now intersects the conveyor's vertical pivot axis illustrates the machine's advance from initial line “A”. To help during the maneuver, drive wheels 23 are on the ground and their hydraulic motors 26 (see FIG. 15) sporadically and briefly operate to ensure the trough maintains position “B”. This completes one work cycle. At this point the conveyor will be retrieved from below the truck's frame and the truck will go forward approximately the same number of meters that the silo bag has increased in length. The entire procedure will be repeated to deploy the conveyor beneath the second downspout toward the truck's rear, or to engage a new truck with a fresh load of grain.

It can be understood how it is convenient to begin the unloading cycle with the conveyor in the maximum forward position allowed by its angular range and any constraints imposed by the truck's wheel assemblies. If the conveyor had commenced its work at point “A” instead of point “B”, it would have reached point “C” completing only half of its full swing before having to reposition for the next cycle, resulting in a loss of time and efficiency.

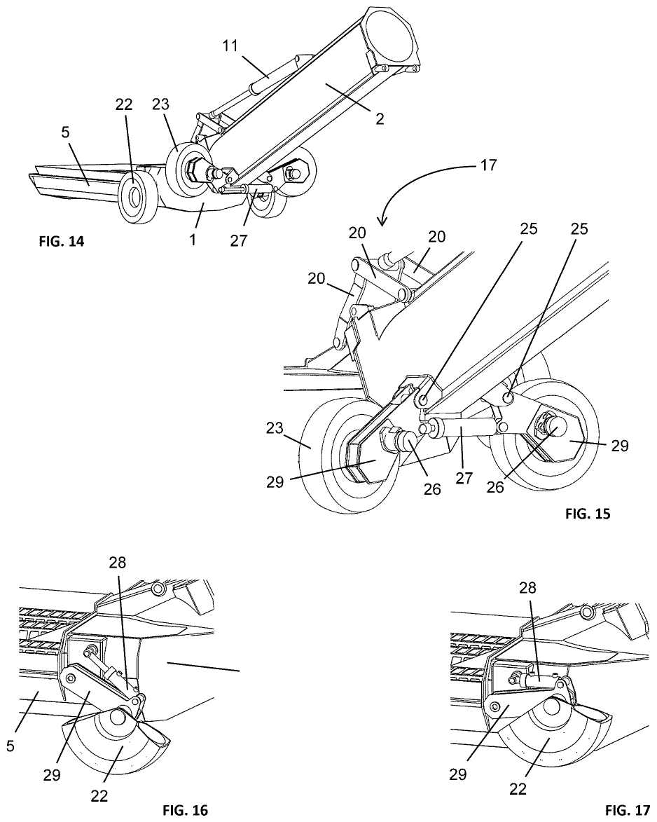

FIG. 14 depicts the conveyor's tubular sections 1 and 2 and grain trough 5 along with drive wheels 23 and free rotatable wheels 22.

Observing now FIG. 15, which is a more detailed view of the conveyor's drive wheel assembly, two “U” shaped brackets can be seen welded to the second tubular section's distal end, one on the lower left side and one on the lower right side of said section, each of which enfolds the end sector of a gear reducer 24 that can pivot freely held by a pin 25 that runs through each “U” bracket. Each gear case is powered by a hydraulic motor 26 that directly drives a gear connected to a larger gear which in turn drives the axle of each drive wheel 23. Gear reducers 24, which being a left side unit and a right side unit are symmetrical mirror images of one another, are linked by a hydraulic cylinder 27. In this manner, besides acting as speed reducers, they also perform as height variable swing arms such that on opening hydraulic cylinder 27 drive wheels 23 are raised up in the air (FIG. 14) and on closing the cylinder they descend to the ground (FIG. 15).

FIGS. 16 and 17 depict one of two freely rotatable wheels 22 mounted on the sides of tubular section 1 and contiguous to grain trough 5. As can be seen, a hydraulic cylinder 28 actuates a swing arm 29 so that when the cylinder opens it pushes the wheels down (FIG. 16), whilst when cylinder 28 closes it raises the wheels up from the ground (FIG. 17).

Wheels 22 and 23 are commanded via the same hydraulic circuit, which is devised so that when one set of wheels rises, the other one descends. Since they never work at the same time this automation is desirable.

FIGS. 18 and 19 show details of the conveyor sector where tube section 3 links to rotatable hopper 6. Hopper 6 is mounted on a ball bearing turntable 37 that permits the conveying assembly's rotation whilst installed over mouthpiece 7, a structure that acts as an antechamber for granular material entry into compression auger 8.

FIG. 18 is a view of the retracted conveyor that shows the square shaped discharge aperture of tubular section 3 and the opening on mouthpiece 7 that leads to the compression auger. A visible element associated with scissors-like hinges 17 and 18 and their articulated blades 20 is rectangular base 38 here seen attached to the underside of tubular section 3. These rectangular bases provide a flat surface to which scissors' pivot pins 21 are welded to in tubular sections 1, 2 and 3 (see also FIG. 24). The end of the screw segments enclosed in tubular sections 2 and 3 can be seen to insert into each other with standard male/female couplings that then lodge together by means of an automatic lock mechanism that engages when the screw turns in the predetermined direction, a mechanism well known to those skilled in the art. Also visible are flanges 59 at the extremities of the tubular sections for the purpose of ensuring a tight fit when closed.

FIG. 19 is a view of the extended conveyor in work position. Tubular section 3 descends and links to rotatable hopper 6 and to mouthpiece 7 for a precise fit with no grain loss.

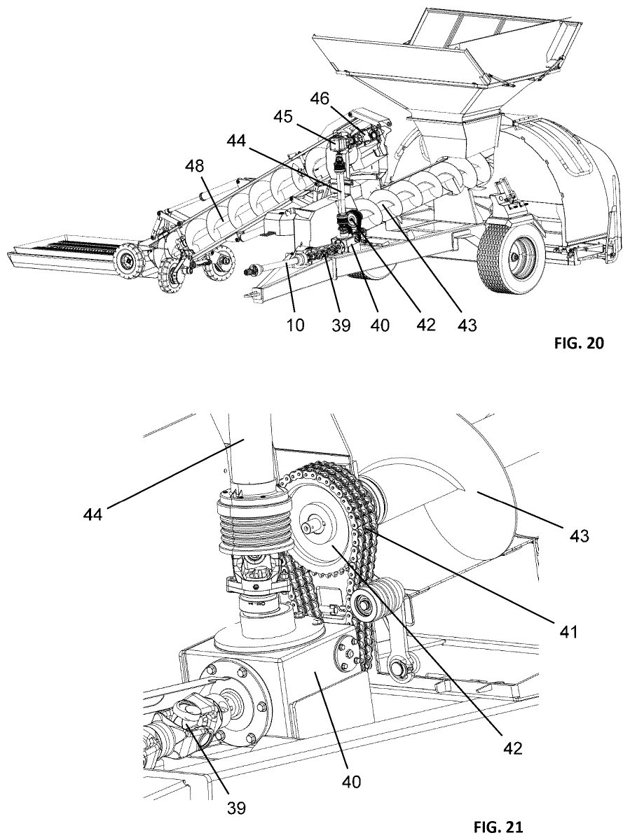

Observing now FIGS. 20 to 22, the unloader's mechanical drive can be analyzed in its generality and its particularities.

FIG. 20 is a cutaway drawing of the unloader depicting the location of the drivetrain's main components to be referenced and examined presently in FIGS. 21 and 22.

FIG. 21 shows a cutaway detailed view of the first section of the drivetrain, where double universal joint 39 linked to PTO drive shaft 10 connects with a right angle dual output gearbox 40. A first gear (not visible) is mounted rotationally on the gearbox's horizontal

output shaft, whereupon a roller chain 41 encircles this first gear and extends upwardly to wrap around a second gear 42 mounted on inner screw 43 of compression auger 8. The second output shaft of gearbox 40 connects by way of a U-joint with a vertically oriented telescopic drive shaft 44.

FIG. 22 is a cutaway detailed view of the drivetrain continuation in which telescopic drive shaft 44 projects upward to connect, by means of a U-joint, with a 1st right angle gearbox 45 which in turn connects to a second right angle gearbox 46. Whilst gearbox 45 is bolted to rotatable hopper 6, it can be seen that gearbox 46 is bolted to a bracket within the space of tubular section 3 (not shown in the drawing as it is a cutaway illustration), which can be clearly ascertained because it lies just below third articulated hinge 19. Rotational movement is transmitted through a roller chain coupling 47 connecting the shafts of gearboxes 45 and 46 and providing a modicum of flexibility to compensate for slight misalignments. Roller chain 47 is mounted within a casing bolted to the sidewall of gearbox 45, and it should be noted that the arrangement provides both a stable pivot point as well as a means for transmitting the rotational movement provided by the drivetrain. Gearbox 46 transmits movement directly to the conveyor auger's inner screw 48. Although inner screw 48 is divided in 3 sections in correspondence with tubular sections 1, 2 and 3, it is denominated as a one-piece part for simplicity's sake since it performs as such when deployed.

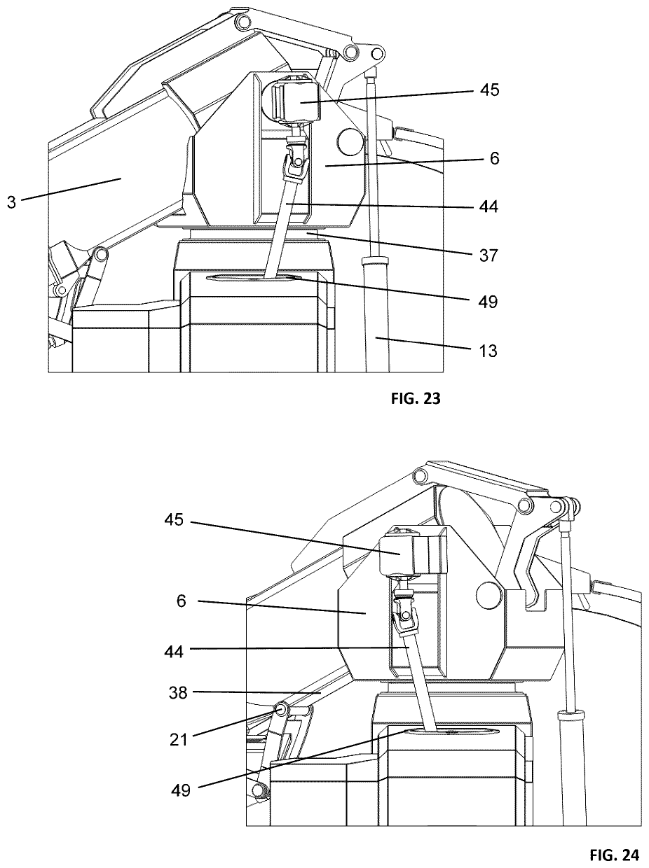

Now FIGS. 23 and 24 show how elements that are part of the mechanical drive system can accompany the gyration of the conveying assembly around the vertical axis determined by rotatable hopper 6, all the time continuing to transmit power.

FIG. 23 shows the conveying auger extended in a forward angled position (see FIG. 12), whereby telescopic drive shaft 44, viewed from the front of the machine, is displaced toward the right side as it accompanies the rotation of hopper 6, its distal end remaining fixed at the junction with gearbox 40 (see FIG. 21). To enable this sideways, partially circular motion of the telescopic shaft, a slot 49 is cut in the fairing that covers the lower section of the transmission mechanism. FIG. 24 shows the telescopic shaft's shift toward the left side when the conveyor is extended in a rearward angled position (see FIG. 13). The trajectory of rotatable hopper 6, and thus the angle that the conveying assembly describes forward and rearward is limited by a pair of fixed hydraulic stops (not shown) installed in the perimeter of mouthpiece 7. These are intersected by detectors on rotatable hopper 6 such that when the conveying assembly reaches its maximum designated aperture in either direction, hydraulic flow is automatically overturned in the corresponding circuit so that when the next receiving trough maneuver is executed, the trough reverses direction.

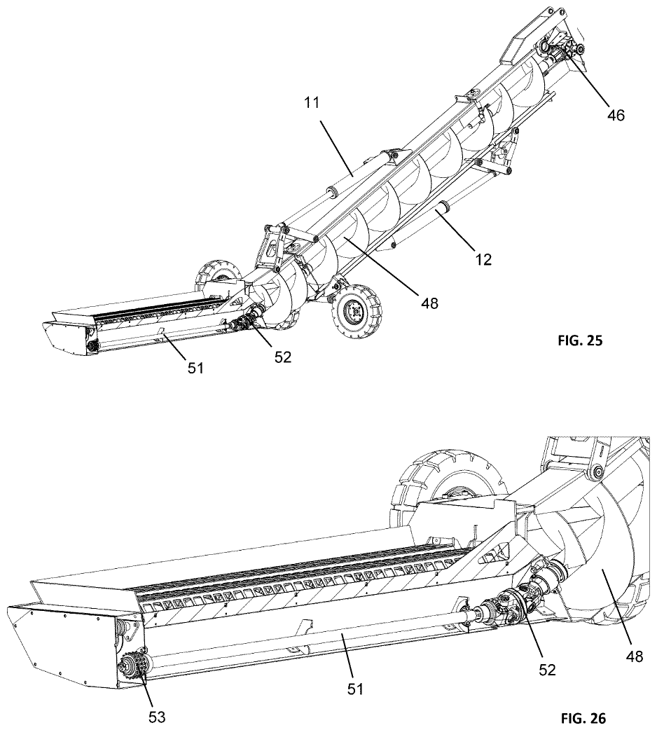

FIGS. 25 and 26 are cutaway perspective views of conveying auger 4 and of connected grain trough 5, with FIG. 26 providing a more detailed view of the interconnection between inner auger screw 48 and grain trough drive shaft 51 through a universal joint assembly 52. At the distal end of drive shaft 51 can be observed a driving sprocket 53.

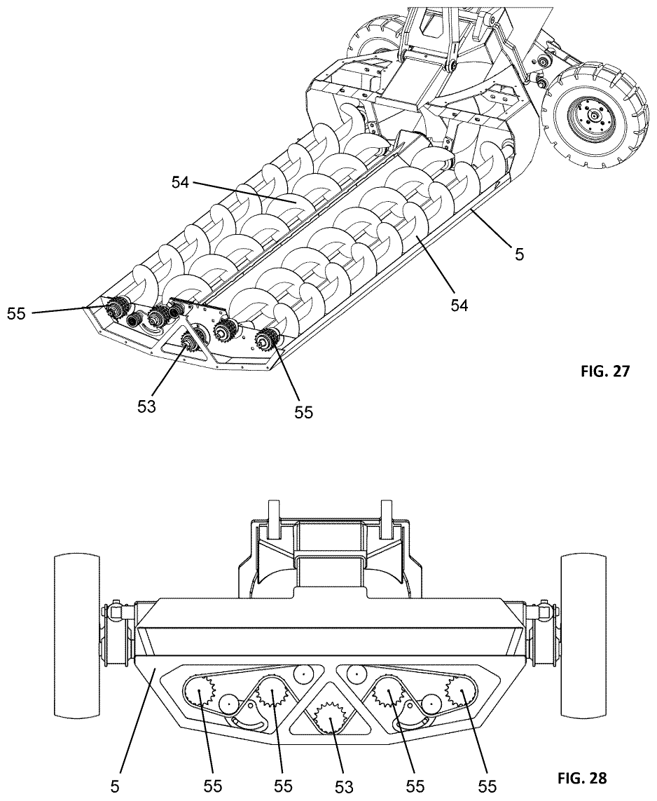

FIG. 27 is a cutaway perspective view of grain trough 5 showing a plurality of sweep augers 54 contiguous to drive shaft 51, their shafts ending in driven sprockets 55. Shaft 50 is concealed by a sheet metal cover but driving sprocket 53 is visible at its extremity. Sweep augers 54 conduct the grain to tubular section 1 for subsequent passage through the conveying assembly.

In FIG. 28 can be seen a drive chain 56 linking driving sprocket 53 and driven sprockets 55. Thus, an entirely mechanically driven system powers all the augers that transport granular material within the machine. Pulleys and belts could be used alternatively instead of sprockets and chains.

Although the present invention has been described herein with reference to the foregoing exemplary embodiment, this embodiment does not serve to limit the scope of the present invention. Accordingly, those skilled in the art to which the present invention pertains will appreciate that various modifications are possible, without departing from the technical spirit of the present invention.

1. An unloading conveyor system for transferring granular material from a vehicle to a grain bagging machine, the unloading conveyor system configured to convey granular material, such as grain, pellets, or dry sand, from a discharge downspout of a vehicle, including a truck, trailer, or grain cart, to a mechanically driven conveying system for grain bagging machines of the type that fill agricultural silo bags, the unloading conveyor system comprising:
a receiving trough configured to be positioned proximate to a ground surface and beneath the discharge downspout of the vehicle, the receiving trough including a plurality of sweep augers configured to collect the granular material;
a conveying auger comprising a first tubular section, a second tubular section, and a third tubular section arranged in series, wherein the first tubular section is coupled at a first end to the receiving trough to receive the granular material therefrom, the first tubular section is pivotally connected at a second end opposite the first end to a first end of the second tubular section via a first horizontal articulation axis disposed at topmost portions of the first tubular section and the second tubular section, enabling relative rotation in a vertical plane, the second tubular section is pivotally connected at a second end opposite the first end to a first end of the third tubular section via a second horizontal articulation axis disposed at lowermost portions of the second tubular section and the third tubular section, enabling relative rotation in the vertical plane, the third tubular section is pivotally connected at a second end opposite the first end to a rotatable hopper via a third horizontal articulation axis extending through the third tubular section and walls of the rotatable hopper, enabling rotation of the third tubular section in the vertical plane, the rotatable hopper is mounted on a turntable configured to rotate in a horizontal plane, and when the first tubular section, the second tubular section, and the third tubular section are deployed, the conveying auger forms a continuous path for the granular material from the receiving trough to the rotatable hopper; and
a compression auger including a mouthpiece configured to receive the granular material, the compression auger disposed transversely relative to the conveying auger, wherein the mouthpiece is positioned beneath the rotatable hopper and connected thereto by a direct passageway configured to permit throughput of the granular material from the rotatable hopper to the compression auger.

2. The unloading conveyor system of claim 1, wherein the first tubular section, the second tubular section, and the third tubular section are configured to fold vertically for stowing by pivoting about the first horizontal articulation axis, the second horizontal articulation axis, and the third horizontal articulation axis, respectively, such that the first tubular section, the second tubular section, and the third tubular section are positioned adjacent to one another and against a central body of the grain bagging machine, and wherein the first tubular section, the second tubular section, and the third tubular section are configured to unfold by pivoting about the first horizontal articulation axis, the second horizontal articulation axis, and the third horizontal articulation axis, respectively, to extend and form a functional conveying auger.

3. The unloading conveyor system of claim 2, wherein the first tubular section, the second tubular section, and the third tubular section each include inner screw segments, respectively, configured such that when the first tubular section, the second tubular section, and the third tubular section are extended, the inner screw segments unfold concurrently and automatically engage with adjacent inner screw segments to form an integrated screw assembly within the conveying auger, the integrated screw assembly configured to rotate cohesively to convey the granular material through the conveying auger.

4. The unloading conveyor system of claim 3, wherein when the first tubular section, the second tubular section, and the third tubular section are folded for stowing, the inner screw segments respectively fold concurrently and automatically disengage from adjacent inner screw segments, thereby ceasing rotational movement of the integrated screw assembly within the conveying auger.

5. The unloading conveyor system of claim 4, wherein the first tubular section and the second tubular section are pivotally connected by a first articulated hinge, the first articulated hinge comprising:
a pair of pivoting blades configured in a scissors-like arrangement, each pivoting blade having a first end attached to a respective pivot pin fixed to the first tubular section and the second tubular section, respectively, and a second end opposite the first end, wherein the second ends of the pivoting blades converge at a common pivot point and are affixed to a third pivot pin; and
a first hydraulic cylinder coupled to the third pivot pin and configured to actuate the pivoting blades to fold and unfold the first tubular section relative to the second tubular section.

6. The unloading conveyor system of claim 5, wherein the second tubular section and the third tubular section are pivotally connected by a second articulated hinge, the second articulated hinge comprising:
a pair of pivoting blades configured in a scissors-like arrangement, each pivoting blade having a first end attached to a respective pivot pin fixed to the second tubular section and the third tubular section, respectively, and a second end opposite the first end, wherein the second ends of the pivoting blades converge at a common pivot point and are affixed to a third pivot pin; and
a second hydraulic cylinder coupled to the third pivot pin and configured to actuate the pivoting blades to fold and unfold the second tubular section relative to the third tubular section.

7. The unloading conveyor system of claim 6, wherein the pivoting blades of the first articulated hinge and the second articulated hinge are transversely connected by steel plates configured to enhance torsional rigidity of the first articulated hinge and the second articulated hinge.

8. The unloading conveyor system of claim 6, wherein the third tubular section and the rotatable hopper are pivotally connected by a third articulated hinge, the third articulated hinge comprising:
a first articulated arm attached at a first end to a proximal end of the third tubular section;
a second articulated arm pivotally connected at a first end to a second end of the first articulated arm, the second articulated arm including a first pivot configured as an anchoring pin attaching the second articulated arm to the rotatable hopper, and a second pivot configured as a pivot pin; and
a third hydraulic cylinder coupled to the second pivot and configured to actuate the second articulated arm to fold and unfold the third tubular section relative to the rotatable hopper.

9. The unloading conveyor system of claim 8, wherein the second pivot of the second articulated arm includes a first ball and socket joint, and wherein the third hydraulic cylinder includes an anchoring support bracket at an opposite end, the anchoring support bracket including a pivot pin supplemented with a second ball and socket joint.

10. The unloading conveyor system of claim 1, wherein the receiving trough includes a pair of freely rotatable wheels laterally positioned and longitudinally aligned with the receiving trough to enable forward and backward movement, the pair of freely rotatable wheels configured to be selectively raised from or lowered to the ground surface.

11. The unloading conveyor system of claim 10, wherein the receiving trough or the conveying auger further includes drive wheels powered by at least one hydraulic motor, the drive wheels being transversely aligned relative to the receiving trough and configured to provide ground movement coordinated with horizontal rotation of the rotatable hopper associated with the conveying auger and the receiving trough, the drive wheels configured to be selectively lowered to the ground surface or raised therefrom.

12. The unloading conveyor system of claim 10, wherein when the receiving trough is deployed and supported by the pair of freely rotatable wheels, the second tubular section and the third tubular section of the conveying auger are configured to extend, enabling rectilinear forward movement of the conveying auger to position the receiving trough directly beneath a discharge downspout of the vehicle transporting the granular material.

13. The unloading conveyor system of claim 1, wherein the unloading conveyor system further includes a mechanically driven conveying mechanism comprising:
a dual output gearbox configured to receive rotational power from a tractor's power take-off or another mechanical power source;
a first output of the dual output gearbox configured to transmit rotational movement to the compression auger; and
a second output of the dual output gearbox configured to transmit rotational movement through a drive shaft to a first right angle gearbox, the first right angle gearbox coupled to a second right angle gearbox via a coupling, the second right angle gearbox configured to transmit rotational movement directly to the integrated screw assembly of the conveying auger.

14. The unloading conveyor system of claim 13, wherein the integrated screw assembly extends the length of the conveying auger when fully deployed, spanning from the third tubular section through the second tubular section to the first tubular section, and wherein the integrated screw assembly is connected to a driving shaft via a universal joint assembly, the driving shaft extending longitudinally through the receiving trough and terminating at a distal end of the receiving trough in a driving sprocket or driving pulley, the plurality of sweep augers being arranged parallel to the driving shaft and each including a driven sprocket or driven pulley at a distal end, the driven sprocket or driven pulley being powered by the driving sprocket or driving pulley via a corresponding driving chain or drive belt.
